(19) United States
(12) Patent Application Publication
(10) Pub. No.: US 2006/0120339 A1
(43) Pub. Date: Jun. 8, 2006

(54) Method of controlling quality of service for a wireless LAN base station apparatus

(75) Inventors: Hiroyuki Akiyama, Tokyo (JP); Takashi Namura, Tokyo (JP); Masahiko Hayashi, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/289,268

(22) Filed: Nov. 30, 2005

(30) Foreign Application Priority Data
Dec. 8, 2004 (JP) 2004-355578

(51) Int. Cl. H04L 12/26; H04Q 7/24; H04L 1/00

(52) U.S. Cl. 370/338; 370/229

(57) ABSTRACT

An access point is provided which is able to secure QoS of multimedia traffic. In the method of controlling QoS for wireless LAN base station apparatus used in a wireless LAN system operating in accordance with IEEE 802.11 standard, the base station or access point is included in a network working in an infrastructure mode with other mobile stations controlled in access by the DCF function. When the access point is receiving a first frame sent from the mobile station and holds a multimedia frame to be sent with high-priority after having received the first frame, it loads the Duration/ID field of an ACK frame responding to the first frame with a time required for transmitting the multimedia frame, and then sends the ACK frame.

### BACKGROUND OF THE INVENTION

1. Field of the Invention

The present invention relates to a method of controlling quality of service (QoS) for wireless local area network (LAN) base station apparatus, or access point apparatus, used in wireless LAN systems.

2. Description of the Background Art

As typical art for wireless LANs, described will be the basic access control system defined as the MAC layer function for wireless LANs by IEEE (Institute of Electrical and Electronic Engineers) 802.11 standard. IEEE 802.11 standard provides two connection ways for wireless LAN networks: ad-hoc mode and infrastructure mode. The ad-hoc mode is a network mode wherein direct communications are made between wireless mobile stations and there is no central or control station in the network. In the infrastructure mode, wireless stations basically communicate via a base station, named an access point (AP), controlling, or functioning as the core of, the network.

The invention is directed to applications for the infrastructure mode, which will therefore be described in more detail. The frame sequence on wireless LANs defined by IEEE 802.11 standard is based on the acknowledgement (ACK) frame response to the unicast frame transmission. However, if the frame is addressed to plural stations, i.e. multicast or broadcast frame, the ACK frame response is not necessary.

In the infrastructure mode access system, there are two functions named DCF (Distributed Coordination Function) using CSMA/CA (Carrier Sense Multiple Access with Collision Avoidance) and PCF (Point Coordination Function) in which collective control of media is carried out via an access point.

Under the DCF control, each station is essentially required to confirm the idle status of the wireless media before starting its frame transmission. If the result from this confirmation indicates that the media are being occupied, or busy, its right to use the media must be suspended until the currently preceding frame transmission is finished. Following the frame transmission completed, when a defined time interval called DIFS plus a time interval called back-off time consisting of a random number given to a specific station have passed, the station is now allowed to transmit its suspended frame.

In the DCF function, there is no master-to-slave relation as established by a master or access point to slaves or ordinary mobile stations in the PCF function. Therefore, any stations including access points are impartially able to access to the media except in the case of beacon transmission, etc.

Under the PCF control, only when a station receives a polling signal from an access point, the station is able to transmit its frame. In the PCF function, the rights to use media are controlled by the access points, so that the ordinary stations are not required to confirm the idle status of the wireless media and wait until the back-off time has passed before starting its transmission.

In CSMA/CA system, a primary system for the DCF control, there are two methods for sensing the status of the wireless media. One method is a physical carrier sensing method in which the carrier is directly sensed by means of a radio frequency (RF) section, such as a radio frequency module, of the physical (PHY) layer, the lower layer of the medium access control (MAC) layer. The other method is a virtual carrier sense method in which use is made of media use reservation information, such as network allocation vector (NAV), set in various frames transmitted over the wireless media. The MAC layer uses the two methods in combination to effectively reduce collision provability caused by media contention among many stations.

The physical carrier sensing is carried out by an RF section, and the MAC layer uses the result therefrom, if necessary, to determine whether or not the carrier exists on the wireless media every one microsecond at the maximum.

The mechanism of the virtual carrier sensing is implemented by means of NAV (Network Allocation Vector). The NAV vector, which is given individually to each station, is a kind of counter having its count decrementing at a constant rate since the point of time at which a value is set until it reaches “0”. The present count the NAV vector has represents a residual time (in microsecond) for using the wireless media reserved and available for a station now transmitting and receiving frames. When the count reaches zero, the NAV vector represents that the wireless media are released and become idle.

At a station in question, now transmitting and receiving frames, the Duration/ID (Identification) field of the MAC header in a frame to be transmitted has to include a scheduled period of time in which the wireless media are to be occupied from now on, i.e. when the current frame has been transmitted. All the stations except the station in question read that field in a frame transmitted on the wireless media, and load its value into the own NAV field for the station at the timing of terminating the transmission of that frame. However, at the loading timing of the NAV field, if the present value of the NAV field of the own station is larger than the value read in from the Duration/ID field of the frame transmitted, this loading is not made.

Now specifically referring first to FIG. 9, the basic NAV control will be described. The stations (STAs) other than a station in question transmitting and receiving frames, at the timing of ending data frame transmission, load their own NAV timers with the value, “6” in this case, set in the Duration/ID field of the Data frame. Then, the NAV timers decrement their counts at a constant rate, and finally reach “0” when an ACK frame has been transmitted. The period of time in which the NAV timer stays not in “0” represents the period in which the media are busy recognized by the virtual carrier sensing.

The interval between the Data frame and the ACK frame is equal to a defined period of time, SIFS, specific to the PHY layer. By the physical carrier sensing alone, the interval may lead to recognizing the media idle. However, by the aid of the virtual carrier sensing it is recognized that the busy status of the media continues until the ACK frame finishes. By contrast, during the transmission of an initial Data frame, the NAV counter has not been set, and the physical carrier sensing leads to recognize that the media are busy. In the figure, the intervals T1 and T2 denote the busy state of the media sensed by the physical carrier sensing. The interval T3 denotes the busy state of the media sensed by the virtual carrier sensing. The MAC layer thus uses the physical carrier sensing and the virtual carrier sensing in combination to determine the busy status of the media, establishing more effective collision avoidance control. In this example, the Duration value of an ACK frame is set to “0”. That causes the media to be released at the timing of the end of the ACK frame.

Any station working under DCF control is able to exchange RTS/CTS (Request To Send/Clear To Send) frames prior to transmitting a desired frame. Specifically, a transmitter station initially uses RTS/CTS frames of a short frame length to exchange the frames with an actual destination station to check the destination station and the transmission path. However, when a desired frame to be transmitted is essentially short, the use of the RTS/CTS frame is rather meaningless, so that the MAC layer uses a prescribed RTS/CTS application threshold parameter to determine whether or not the application of RTS/CTS is suitable. Basically, the RTS/CTS control is not applied to frames having the length thereof shorter than the threshold parameter, but only to those having the length thereof longer than the threshold parameter. To the RTS/CTS frame, the NAV control mentioned above is also applied as with ordinary data frames.

Now, referring to FIG. 10, the RTS/CTS frame sequence and its NAV control will be described. In the RTS/CTS frame sequence, the intervals between RTS and CTS frames, between CTS and Data frames and between Data and ACK frames are all set to the shortest time interval, equal to SIFS, among the defined various frame intervals. Therefore, if the RTS/CTS frames are successfully exchanged, the station can use the wireless media with priority over other stations that intend to send their frames after a time interval, DIFS, longer than the SIFS interval has passed, and thus the transmission of successive Data/ACK frames will be achieved with a higher probability.

As seen from FIG. 10, the Duration/ID field of each frame has its value indicating a period of time required (in microsecond) from the end of transmitting the frame to the end of transmitting an ACK frame, and therefore the final ACK frame has its value equal to “0”. In the figure, Dur(AAA) denotes the duration value of a frame AAA, SIFS is set to a value specific to the physical layer, and T(AAA) denotes a time period necessary for transmitting a frame AAA.

When the wireless media have, as a result of the decision by the virtual and physical carrier sensing, the status thereof idle from the busy status and a required time interval, which is ordinarily the DIFS interval, has passed, if some stations storing their data waiting for transmission start the transmission, collision may occur between media accesses with higher possibility. To avoid the collision, IEEE 802.11 standard provides the back-off procedure.

Referring now to FIGS. 11A and 11B, the basic function of the back-off procedure will be described. In the figure, the stations STA1, STA2 and STA3, when having data stored waiting transmission, determine by the physical and virtual sensing that the wireless media are busy (or are in the DIFS period just after the busy status), and become suspended from the right of using the media. When the current frame was transmitted and the successive DIFS time interval has passed, the media become cleared or released and idle. However, if those suspended stations start sending the frames pending at once, then the accesses therefrom rush in a very narrow timing period, as seen in FIG. 11A, thus causing the accesses to collide against each other with a higher probability.

In order to reduce the collision probability, each station is required to suspend its media access for a period of time, back-off time, which is randomly selected, in addition to the DIFS interval. Thus, the probability of collision between plural media accesses can be reduced, as illustrated in FIG. 11B.

In addition to the DCF access system mentioned above, IEEE 802.11 standard provides the PCF access system as an optional wireless media access system in the infrastructure mode. In the PCF access system, a master station, which is ordinarily an access point and named point coordinator (PC) is adapted to centrally control the sender rights of all stations. Therefore, as different from the DCF system, the PCF access system is free from contention about the sender right between the wireless stations.

The conventional wireless LAN systems mainly deal with data traffic. However, reflecting the recent development and spread of multimedia technology, for example, VoIP (Voice over IP), needs are increasing to deal with multimedia traffic, such as voice and motion picture traffic, integrally with traditional data traffic on the wireless LAN systems.

The multimedia traffic is specifically unique in its periodicity and sensitivity to delay. If multimedia traffic periodically produced by a sender station is subjected to an excess delay and a variation of the delay or an excess information loss over an allowable threshold on the transmission path, then it may be deteriorated, when reproduced at a receiver station, to the extent that the quality of voice and motion picture etc., could not be evaluative.

However, the DCF access system described above according to IEEE 802.11 standard is essentially designed to effectively transmit asynchronous data in burst and unpredictable. It is therefore possible that data may considerably be varied in delay due to traffic jam over the network. For regular and periodic multimedia traffic, it is difficult to reduce the amount of transmission delay and the variation of the delay to thereby secure the QoS (Quality of Service), which is an indicator of improvement of the transmission delay time and its fluctuation caused by wireless transmission.

The PCF access system described above according to IEEE 802.11 standard is suitable for transmitting the regular and periodic multimedia traffic. However, due to the fact that the PCF access system is defined as an option of the DCF system, it is not generally used at present, and is therefore not a popular solution in practice.

### SUMMARY OF THE INVENTION

It is an object of the present invention to provide an access point applicable to stations, operating under the DCF access system and widely spread, with modification made exclusively so as to secure the QoS required for multimedia traffic.

According to the present invention, a method of controlling the QoS for wireless LAN base station or access point apparatus used in wireless LAN systems reduces, according to the service classes, the amount of transmission delay time and transmission delay time fluctuation caused by wireless transmission, and thus improving the QoS of the system.

In accordance with the present invention, the invention provides a method of controlling QoS for wireless LAN base station apparatus used in a wireless LAN system operating in accordance with IEEE 802.11 standard, wherein the base station is included in a network working in an infrastructure mode with a mobile station controlled in access by the DCF function. In the method, when the base station is receiving a first frame sent from the mobile station and holds a multimedia frame which is to be sent with high-priority after having received the first frame, the base station loads the Duration/ID field of an acknowledgement frame responding to the first frame with a period of time for transmitting the multimedia frame, and sends the acknowledgement frame.

Also in accordance with the invention, when the base station is transmitting a first frame to the mobile station and holds its a multimedia frame to be sent with high-priority after having transmitted the first frame, the base station adds a period of time required for transmitting the multimedia frame to the time of the Duration/ID field of the first frame to send the first frame.

Further in accordance with the invention, when the base station is receiving a first frame sent from the mobile station and predicts a reception of a multimedia frame with high-priority from a specific mobile station after having received the first frame, the base station loads the Duration/ID field of an acknowledgement frame responding to the first frame with a period of time required for receiving the multimedia frame, and sends the acknowledgement frame. The base station thereafter carries out, with the specific mobile station, a sequence of clearing the NAV timer of the specific mobile station.

In addition, in accordance with the invention, when the base station is transmitting a first frame to the mobile station and predicts a reception of a multimedia frame with high-priority from a specific mobile station after having transmitted the first frame, the base station loads the Duration/ID field of the first frame with a period of time added by a time required for receiving the multimedia frame to send the first frame, and thereafter carries out, with the specific mobile station, a sequence of clearing the NAV timer of the specific mobile station.

In the method in accordance with the invention of controlling QoS for wireless LAN base station apparatus used in a wireless LAN system operating in accordance with IEEE 802.11 standard, when high-priority frames are transmitted between the access point and the mobile station, a value that is not zero is set to the Duration/ID field. With the specific station, a control sequence is carried out to clear the NAV timer of the mobile station. It is thus possible to remarkably increase the probability at which the base and mobile stations can secure their rights of using the communication media, and thus to improve the QoS of the system.

### BRIEF DESCRIPTION OF THE DRAWINGS

The objects and features of the present invention will become more apparent from consideration of the following detailed description taken in conjunction with the accompanying drawings in which:

FIG. 1 schematically shows a system including an access point to which the present invention is applied;

FIG. 2 is a schematic block diagram of a preferred embodiment of the access point according to the invention;

FIGS. 3 through 8 are timing charts useful for understanding the transmission of data between the access point and the stations in accordance with the embodiments;

FIG. 9 is a schematic diagram useful for understanding the basic function of NAV control;

FIG. 10 is a schematic diagram useful for understanding the RTS/CTS frame sequence and the NAV function; and

FIGS. 11A and 11B are schematic diagrams useful for understanding the basic function of the back-off time.

### DESCRIPTION OF THE PREFERRED EMBODIMENT

The method of controlling QoS for wireless LAN base station apparatus according to the invention will be described in more detail with reference to the accompanying drawings. The figures of the drawings are drawn conceptually and schematically to the extent that the invention can fully be understood. Like components are designated with the same reference numerals.

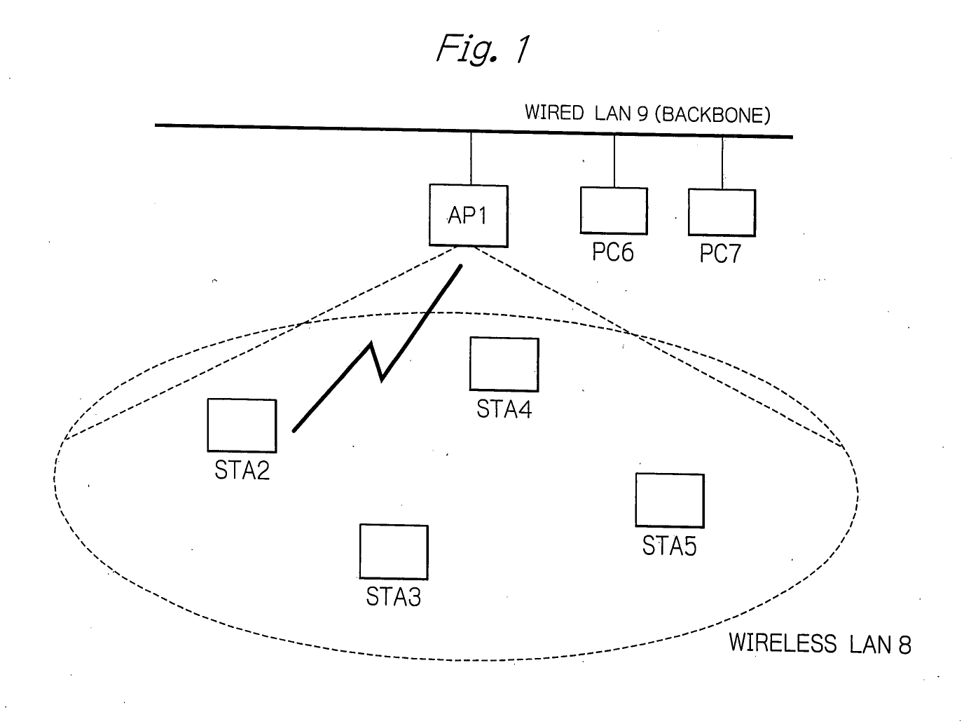

With reference to FIG. 1, the system to which the invention is applied includes an access point AP1 according to the invention, existent wireless LAN stations STA2-STA5, and existent terminals PC6 and PC7, such as personal computers. The access point AP1 and the wireless station STA2-STA5 form a wireless LAN 8, and the access point AP1 and terminals PC6 and PC7 are interconnected to a wired LAN 9 serving as a backbone network. The stations STA2-STA5 are adapted to transmit and receive wireless frames always via the access point AP1. With the illustrative embodiment, the wireless LAN 8 is a network operating in an infrastructure mode defined by IEEE 802.11 standard.

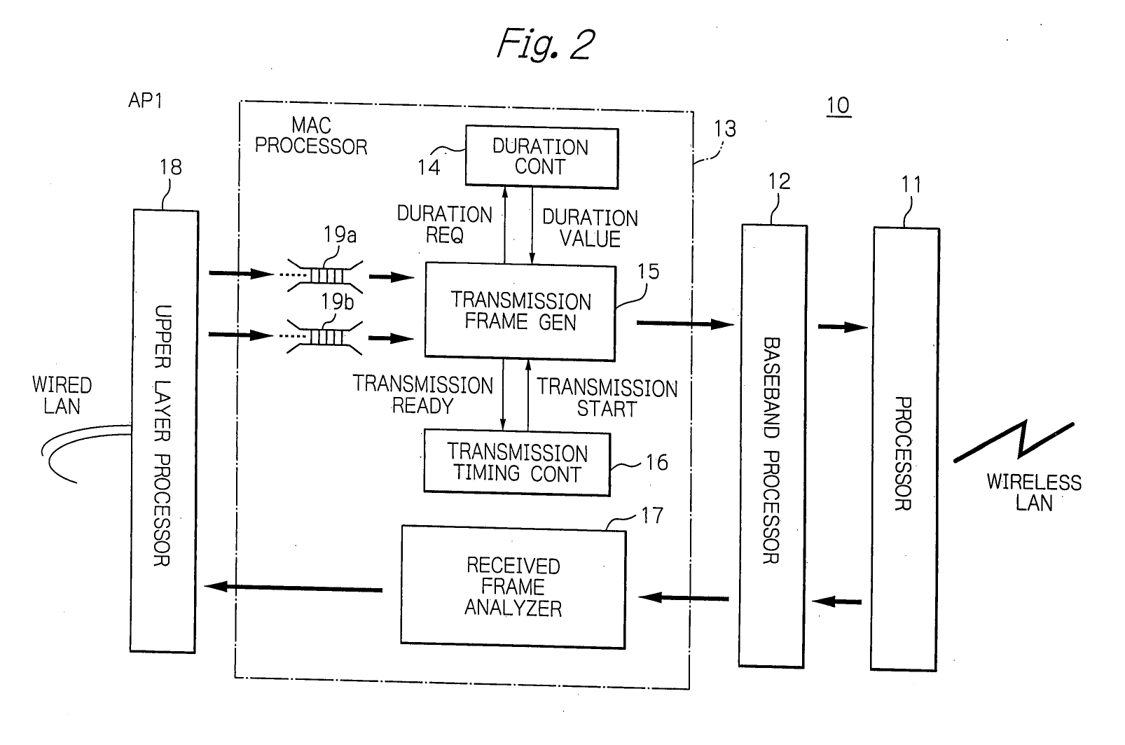

FIG. 2 is a schematic block diagram showing the access point AP1, generally designated with a reference numeral 10, according to the invention. The access point 10 comprises a radio frequency (RF) processor 11, a base-band processor 12, a MAC processor 13 and an upper layer processor 18, which are interconnected as illustrated. The MAC processor or processing unit 13 includes a high-priority traffic cue 19a, a low-priority traffic cue 19b, a duration controller 14, a transmission timing controller 16, a transmission frame generator 15 and a reception frame analyzer 17.

Referring to FIGS. 1 and 2, the basic operation of the system of the illustrative embodiment will be described in connection the flow of important signals. In reference to FIG. 1, for example, an upper layer packet generated at the terminal PC6 arrives at the access point AP1 over the wired LAN 9. With reference to FIG. 2, the access point AP1 carries out necessary terminal processing for the wired LAN 9, and then makes entry of a request for transmission of a received upper layer packet, according to its priority, to the high- or low-priority traffic cues 19a or 19b in the MAC processor 13.

The transmission frame generator 15 reads out the cue information thus entered, and provides the duration controller 14 with a request for generating Duration so as to generate Duration information. The frame generator 15 also generates MAC header information, such as the MAC addresses of the sender and receiver, sequence numbers, and a frame check sequence (FCS) field for transmission error watching. The frame generator 15 in turn informs the transmission timing controller 16 of the transmission ready.

The transmission timing controller 16 watches the idle status of the wireless media, and forwards, following a required time interval provided, an instruction for starting the transmission to the transmission frame generator 15. In response to the instruction for starting the transmission, the transmission frame generator 15 outputs the frame data together with control information, such as transmission frame length and transmission rate, to the base-band processing unit or processor 12.

The base-band processor 12 carries out the generation of a PLCP header and a preamble, pudding addition and the necessary processing for coding and modulation such as DSSS or OFDM on the frame data, and then outputs the resultant data together with information about transmission power and antenna selection to the RF processor 11. The RF processor 11 carries out necessary processing such as digital-to-analog (D/A) conversion, in-phase/quadrature (I/Q) modulation, and finally wireless transmission of the data. The basic operation of the system of the embodiment has been described in respect of the downward direction, i.e. from the access point AP1 to the stations.

Next, the basic operation of the system in the upward direction, i.e. from the stations to the access point AP1, will be described. When the RF processor 11 determines the receiver field intensity of the wireless media exceeding a predetermined threshold level, the base-band processor 12 starts the receiving operation to receive the data of received frame A/D-converted. The base-band processor 12 carries out demodulation and extracts the frame data of the MAC layer and outputs the latter to the MAC processor 13.

The MAC processor 13 carries out the terminal processing for the MAC layer, and makes necessary responses such as ACK/CTS response and a response to the authentication/association request. When the data frame is loaded with an upper layer packet, it is transferred by the MAC processor 13 to the upper layer processor 18 together with address information of an ultimate destination. The upper layer processor 18 sends out the upper layer packet toward the destination of that address over the wired LAN 9.

On the basis of the above-mentioned basic operation, the operation of the wireless LAN base station apparatus of the embodiment will be described in respect of various aspects. At first, voice communication using the VoIP protocol will be described which is carried out between the terminal PC6 connected to the wired LAN 9 and the station STA2 connected to the wireless LAN 8.

Voice communication using the VoIP technology implements both-way transmission of voice information between both the terminal and the station at the regular, periodic time intervals of ordinarily several dozens milliseconds. Observing the downward direction, as shown in FIG. 1, voice information packets periodic sent from the terminal PC6 arrive at the access point AP1 over the wired LAN 9, and are entered into the high-priority traffic cue 19a of the MAC processor 13, FIG. 2. The access point AP1, generally 10, sends out without delay the voice information thus entered to the high-priority traffic cue 19a in the form of MAC frame to the destination, station STA2.

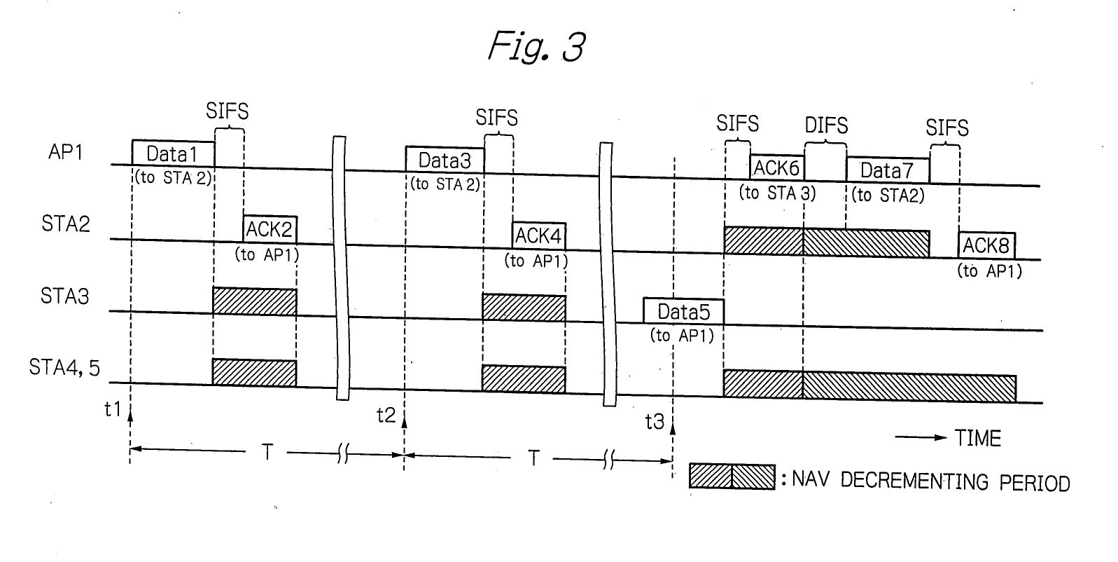

Specifically, with reference to FIG. 3, a timing chart demonstrating how frames are transmitted between the access point AP1 and the stations, Data1 and Data3 represent the voice information transmitted from the access point AP1 to the station STA2 at the time points t1 and t2 of the downward voice traffic generated. These frames are generated at periodic time intervals T. The access point AP1 sends out Data1 and Data3. Thereafter, when the defined time intervals SIFS have respectively passed, the access point AP1 receives acknowledgement frames ACK2 and ACK4 sent from the station STA2, and thereby recognizes that the respective frame transmission sequences have successfully finished.

In this case, the remaining stations STA3, STA4 and STA5 determine that the Data1 and Data3 are the frames meant to the stations other than themselves. The stations STA3, STA4 and STA5 therefore load the Duration value set in Data1 and Data3 into their own NAV timers at the timing of the end of reception of the Data1 and Data3. The stations STA3, STA4 and STA5 then continue to decrement their NAV timers until the transmission of the successive ACK frames has finished. The stations STA3, STA4 and STA5, while decrementing the NAV timers, cannot get the sender right for the wireless media.

At the same timing as the ACK frame transmission has finished, the NAV timers reach “0”, so that the wireless media are released to the free contention. The ACK frame has its Duration value ordinarily set to “0”, and therefore the NAV timers are not loaded at the timing of the end of receiving the ACK frame.

At the following timing t3, voice traffic is generated in the downward direction, and the access point AP1 is now receiving Data5 sent from the station STA3. The access point AP1 therefore cannot immediately send out the voice information, Data 7. Under that circumstance, when the access point AP1 sends out an acknowledging frame ACK6 as a response to Data 5 to the station STA3, it sets the Duration value of the acknowledging frame to a value other than “0”, which is usually “0” for acknowledgement frames. That value, other than zero, is calculated to be equal to a period of time necessary from the timing of the end of transmission of the frame ACK6 to the timing of the end of transmission of the frame ACK8, i.e. “DIFS+transmission time for Data7+SIFS+transmission time for ACK8”.

Well, the other stations STA2, STA4 and STA5 that are not involved in the transmission and reception of the frames have their NAV timers continue to decrement from the value equal to the Duration value set in Data5 and reach “0” at the timing of the end of transmission of the frame ACK6. Those NAV timers will further continue to decrement with a value loaded which is equal to the Duration value set in the frame ACK6.

The access point AP1, having sent out the frame ACK6, confirms that the wireless media has maintained the idle status thereof for the successive DIFS time interval, and thereafter sends out the Data7 including the voice information to the station STA2. Since the stations STA2, STA4 and STA5 other than the station STA3, which was a transmitter/receiver in the preceding sequence, continue to decrease their NAV timers, the access point AP1 will be allotted with the right of using the media with much higher priority than usual to send out the frame Data7.

In summary, when the access point AP1 holds a multimedia frame to be sent with high-priority after the reception currently preceding, it sets to an ACK frame to be sent having its Duration value other than “0” and calculated as “DIFS+transmission time for Data+SIFS+transmission time for ACK”, while the stations other than the station to which the ACK frame is sent have their NAV timers continue to decrease. That makes it possible to remarkably increase the probability at which the access point AP1 can secure its right of using the media next time in the downward direction, thus improving the QoS of the wireless media in the downward direction.

Further to the basic operation described above, another operation of the wireless LAN base station apparatus of the illustrative embodiment will be described, in which voice communication under the VoIP protocol is also carried out between the terminal PC6 connected to the wired LAN 9 and the station STA2 connected to the wireless LAN 8.

Similarly to the description above, observing the voice communication in the downward direction under the VoIP protocol, voice information packets periodically sent from the terminal PC6 arrive at the access point AP1 over the wired LAN 9, FIG. 1, and are entered into the high-priority traffic cue 19a of the MAC processor 13, FIG. 2. The access point AP1 sends out the voice information thus entered to the high-priority traffic cue 19a in the form of MAC frame to the destination, station STA2.

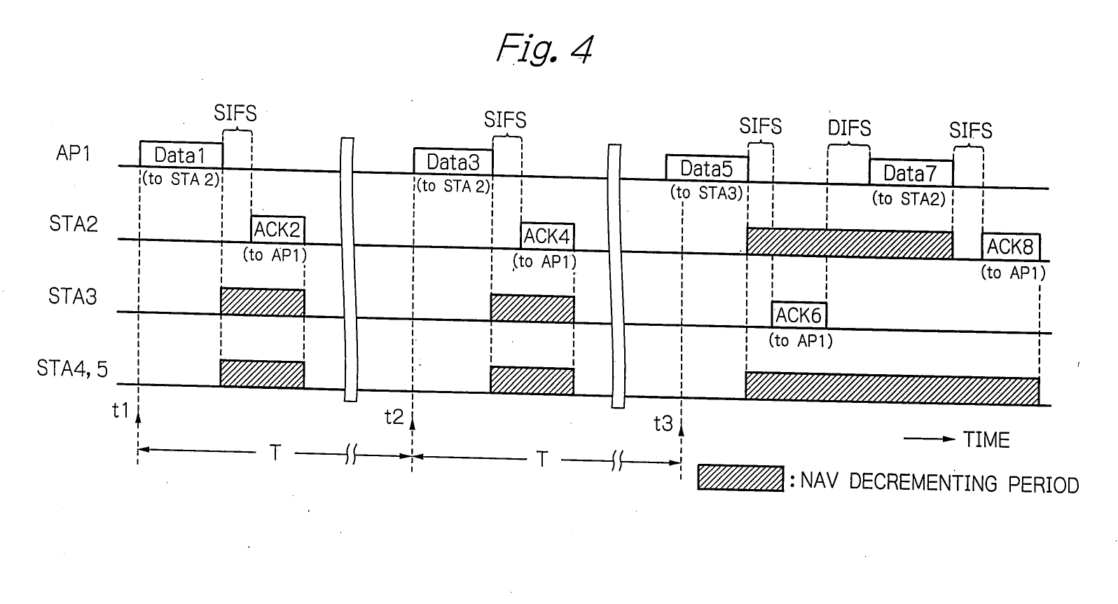

FIG. 4 is a timing chart useful for understanding how frames are transmitted between the access point AP1 and the stations. In the figure, Data1 and Data3 represent the voice information transmitted at the time points t1 and t2 of the downward voice traffic generated, and these frames are generated at periodic time intervals T.

At the next timing t3 of down voice traffic generated the access point AP1 has just started transmitting Data5 to the station STA3, and is therefore not ready to send Data7, the voice information, at once. Under the circumstance, the access point AP1 changes the Duration value to be set in Data5 to a value larger than the ordinary value. The larger value is calculated to be equal to a period of time necessary from the timing of the end of transmission of the frame Data5 to the timing of the end of transmission of the frame ACK8, i.e. equal to “SIFS+transmission time for ACK6+DIFS+transmission time for Data7+SIFS+transmission time for ACK8”.

At the timing of the end of transmission of the frame Data5, the other stations STA2, STA4 and STA5 not involved in the frame transmission/reception load their NAV timers with the Duration value set in the Data5, and start decrementing them.

The station STA3, having received the Data5, sends the frame ACK6 as a response to the access point AP1. The Duration value to be set in that frame ACK6 is usually expected to be “0”. However, at this time point, the stations STA2, STA4 and STA5 have their NAV timers still containing a value larger than “0”, and therefore do not yet proceed to load the timers under that circumstance, thus continuing to decrement them until the transmission of the frame ACK8 has finished.

The access point AP1 having received the frame ACK6 confirms that the idle status of the wireless media has lasted for the successive DIFS time interval, and thereafter sends the frame Data7 including voice information to the station STA2. In respect of transmitting the frame Data7, since the stations STA2, STA4 and STA5 continue to decrease their NAV at that point of time, the access point AP1 will be able to get the right of using the media with much higher priority than the ordinary case. The station STA2 receives the Data7 from the access point AP1, and thereby clears its NAV timer. The station STA2 in turn sends out the frame ACK8 as a response to the access point AP1.

In short, when the access point AP1 holds a multimedia frame to be sent with the high-priority after the current transmission has finished, it sets the Data frame ready to send with a Duration value that is larger than the ordinary value as is calculated from the expression “SIFS+transmission time for ACK+DIFS+transmission time for Data+SIFS+transmission time for ACK”, thus causing the stations other than the destination station to which the Data frame is meant to load the value into their NAV timers. It is thus possible to remarkably increase the probability at which the access point AP1 can secure its right of using the media next time in the downward direction, thus improving the QoS of the wireless media in the downward direction.

On the basis of the basic operation described earlier, a further operation of the wireless LAN base station apparatus will be described, in which a voice communication under the VoIP protocol is also carried out between the terminal PC6 connected to the wired LAN 9 and the station STA2 connected to the wireless LAN 8.

Observing the voice communication using the VoIP technology in the upward direction, the access point AP1, FIG. 1, periodically receives a wireless frame including a packet conveying voice information sent from the station STA2. In reference to FIG. 2, the received frame passes through the RF processor 11 and the base-band processor 12 to the MAC processor 13, which in turn carries out thereon the MAC layer terminal processing. The voice information frame is then transferred through the upper layer processor 18 to be sent to the wired LAN 9, and finally arrives at the terminal PC6.

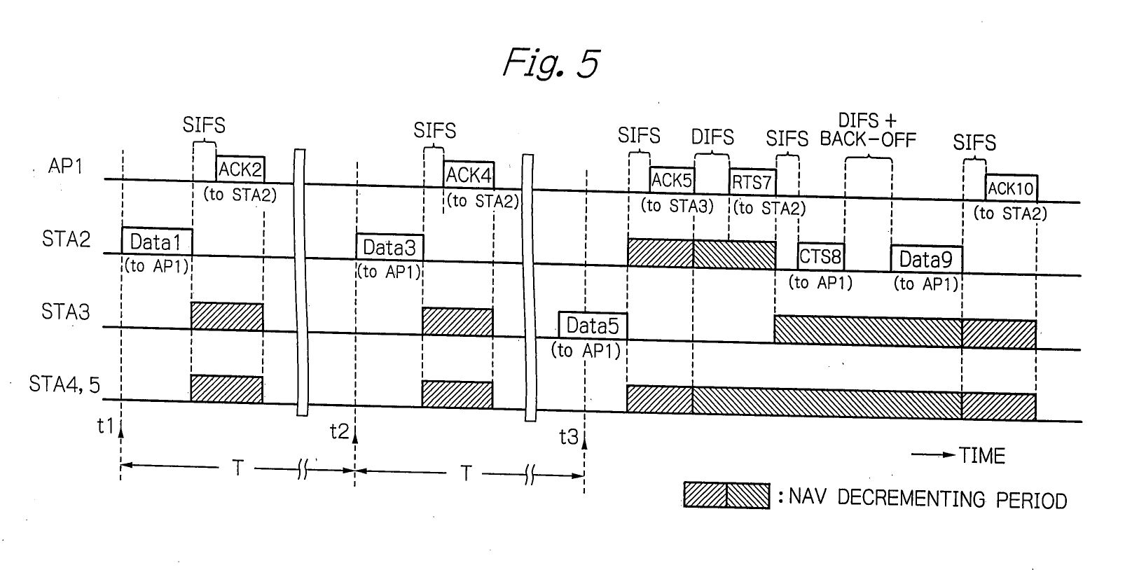

FIG. 5 is a timing chart demonstrating the transmission of frames between the access point AP1 and the stations. In the figure, Data1 and Data3 represent the frames of voice information transmitted from the station STA2 to the access point AP1 at the timing points t1 and t2 of generating voice traffic in the upward direction. These frames are generated periodically at the time interval T. The access point AP1 stores an identification of a wireless LAN station currently under the voice communication, and predicts, based on the history, the next timing of voice traffic which may be generated in the upward direction. That is depicted in the figure as the timing t3 of the voice traffic generation in the upward direction.

In FIG. 5, it is also shown that at that predicted timing the access point AP1 is receiving Data5 from the station STA3 and is therefore not able to receive next voice information immediately. Under the circumstance, the access point AP1, when transmitting the frame ACK6 as a response to the Data5, sets the Duration field, which ordinarily contains “0” for an acknowledgement, to a value other than “0”. That value is calculated to be equal to the necessary time from the timing of the end of transmission of the frame ACK6 to the timing of the end of transmission of the frame ACK10, i.e. “DIFS×2+SIFS×2+back-off time+transmission time for (RTS 7, CTS8, Data9 and ACK10)”. In the calculation, the back-off time means a waiting time made by the back-off function of the station STA2. However, because the back-off time is a random value and therefore not predicable exactly, it is set to a probable average value.

Now, at the other stations STA2, STA4 and STA5 not involved in the current transmission of the frames, their NAV timers decreasing from the Duration value set in Data5 reach “0” at the timing of the end of transmission of the frame ACK6. However, they are further loaded with the Duration value set in the frame ACK6 to continue to decrement.

The access point AP1 having transmitted the frame ACK6 confirms that the idle status of the wireless media has lasted for the successive DIFS time interval. Thereafter, the access point AP1 now sends the frame RTS7 to the station STA2. The frame RTS7 has its Duration value set to a value resultant from subtraction of “DIFS+transmission time for RTS7” from the Duration value for the frame ACK6.

The station STA2 receives the frame RTS7, and in response clears its own NAV timer. The station STA2 then sends the frame CTS8 as a response to the access point AP1. The station STA3 receives the frame RTS7, and thereby loads its own NAV timer with the Duration value set in the RTS frame to start decrementing the timer. At this point of time, the station STA3 starts decrementing its NAV timer, and the other stations STA4 and STA5 still continue to decrement their NAV timers. Therefore, the station STA2 proceeds to the ordinary procedure (DIFS+back-off) before sending its frame Data9. Ultimately, the station STA2 will obtain the right of using the media with higher priority.

As described above, when the access point AP1 predicts, following the completion of the receiving operation, a reception of a multimedia frame with the high-priority from a station, it loads the ACK frame to be sent with a Duration value that is not “0” but is calculated from the expression “DIFS×2+SIFS×2+back-off time+transmission time for (RTS7, CTS8, Data9 and ACK10)”, thereby causing the stations other than the station to which the ACK frame is sent to continue to decrement their NAV timers. Further, the access point AP1 carries out the RTS/CTS sequence between the predicted station in question. Therefore, it is possible to remarkably increase the probability at which the predicted station in question is able to secure its right of using the media next time in the upward direction, thus improving the QoS of the wireless media in the upward direction.

In that way, the predicted station is caused to clear its NAV timer, thus assuring the predicted station to obtain its right of using the media next time in the upward direction. However, other types of frame, such as a unicast management/control frame or a data frame, available in wireless LANs may be used to clear the NAV timer of predicted stations, thus accomplishing the same operation as described above.

In addition, the ACK frame may have its Duration value smaller than the value described above, e.g. a value that reaches “0” during the succeeding frame sequence, with the RTS/CTS sequence and other types of frame, such as a unicast management/control frame or a data frame, available in wireless LANs used in respect of the predicted station to allow the stations other than the predicted station to set the NAV timers thereof (in this case, the function to clear the NAV timer of the predicted station may not be necessary), thus attaining the same operation as described above.

Further to the basic operation described earlier, a still further operation of the wireless LAN base station apparatus will be described, in which voice communication using the VoIP protocol is also carried out between the terminal PC6 connected to the wired LAN 9 and the station STA2 connected to the wireless LAN 8.

Observing the voice communication on the basis of the VoIP technology in the upward direction, the access point AP1, FIG. 1, periodically receives a wireless frame including a packet of voice information sent from the station STA2. Through the RF processor 11 and the base-band processor 12, FIG. 2, the received frame is applied to the MAC processor 13, which in turn carries out the MAC layer terminal processing on the received frame. The frame is then transferred through the upper layer processor 18 to the wired LAN 9, and finally arrives at the terminal PC6.

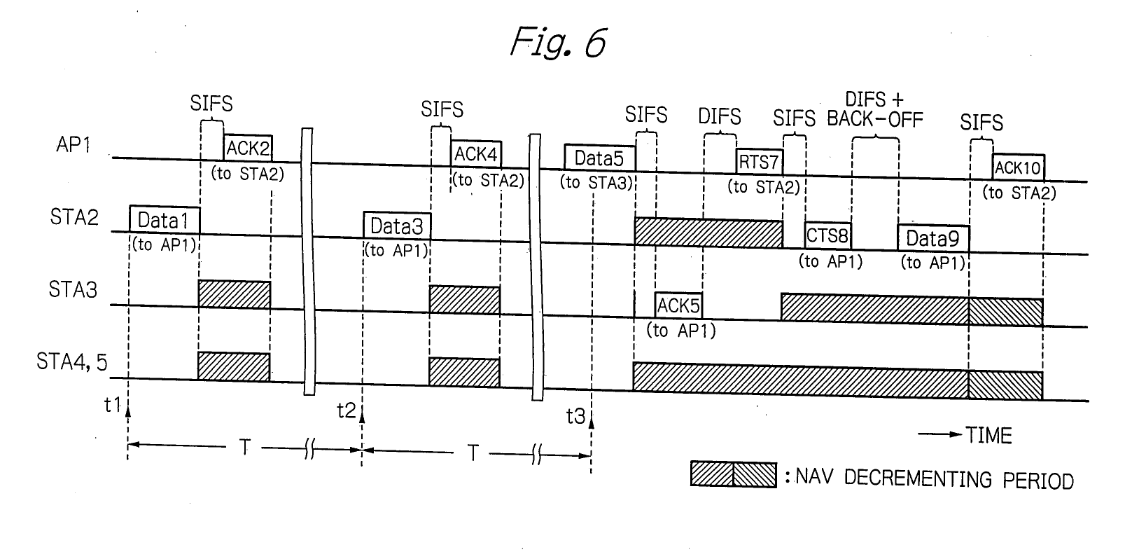

FIG. 6 is a timing chart useful for explaining the transmission of frames between the access point AP1 and the stations. In FIG. 6, the Data1 and Data3 represent the frames carrying voice information transmitted from the station STA2 to the access point AP1 at the timing points t1 and t2 of generating voice traffic in the upward direction, these frames periodically being generated at a time interval T. The access point AP1 stores the identification of a wireless LAN station currently involved in the voice communication, and predicts, based on the history, the timing of next voice traffic which may be generated in the upward direction. The timing is indicated with the time point t3 at which the voice traffic is generated in the upward direction.

In FIG. 6, it is shown that at the predicted timing the access point AP1 is sending Data5 to the station STA3 and is not ready to immediately receive voice information when successively transmitted from the station STA2. In this case, the access point AP1 changes the Duration value to be set in the Data5 to a value larger than the ordinary value. The larger value is calculated to be equal to the time necessary from the timing of the end of transmission of the frame Data5 to the timing of the end of transmission of the frame ACK10, i.e. equal to “DIFS×2+SIFS×3+back-off time+transmission time for (RTS7, CTS8, Data9 and ACK10)”. In the calculation, the back-off time means a waiting time made by the back-off function of the station STA2. However, because the back-off time is a random value not predicable exactly, it is set to a probable average value.

Now, the other stations STA2, STA4 and STA5 that are not involved in the transmission and reception of the frames load, at the timing of the end of transmission of frame Data5, their NAV timers with the Duration value set in Data5, and start decrementing them.

The station STA3, having received the frame Data5, sends the frame ACK6 as a response to the access point AP1. The Duration value set in the ACK frame is expected to be “0” as its ordinary value. However, at that point of time, since the NAV timers of stations STA2, STA4 and STA5 still have a value larger than “0”, they are not yet loaded with the Duration value but continue to decrement.

The access point AP1, having received the frame ACK6, confirms that the wireless media keeps its idle status for the successive DIFS time interval, and now sends the frame RTS7 to the station STA2. As the Duration value for the frame RTS7, a value is set which is resultant from the subtraction of “SIFS+DIFS+transmission time for (ACK6 and RTS7)” from the Duration value for the frame Data5.

The station STA2 receives the frame RTS7, and in response clears its own NAV timer to then send the frame CTS8 as a response to the access point AP1. On the other hand, the station STA3, having received the frame RTS7, loads thereby its own NAV timer with the Duration value set in the RTS frame, and starts decreasing the timer. At this point of time, the station STA3 starts decrementing its NAV timer, and the other stations STA4 and STA5 still continue to decrement their NAV timers. Therefore, the station STA2 proceeds to the ordinary procedure (DIFS+back-off) before sending its frame Data9. The station STA2 will ultimately get the right of using the media with higher priority.

In summary, when the access point AP1 predicts multimedia frames with the high-priority to be received from an station after the present transmission has finished, it sets the Data frame to be sent to a Duration value that is larger than the ordinary value and is calculated from the expression “DIFS×2+SIFS×3+back-off time+transmission time for (ACK6, RTS7, CTS 8, Data9 and ACK10)”, and causes the stations other than the station to which the Data frame is sent to their NAV timers with that value. Further, the access point AP1 carries out the RTS/CTS sequence between that predicted station, and clears the NAV timer of the predicted station. Therefore, it is possible to remarkably increase the probability at which the predicted station is able to secure its right of using the media next time in the upward direction, and to thereby improve the QoS of the wireless media in the upward direction.

In the way stated above, the predicted station is caused to clear its NAV timer, thus assuring the predicted station to obtain its right of using the media next time in the upward direction. However, other types of frame, such as a unicast management/control frame or a data frame, available in wireless LANs may be used to clear the NAV timer of predicted stations, thus accomplishing the same operation as described above.

In addition, the Data frame may have its Duration value smaller than the value described above, e.g. a value that reaches “0” during the succeeding frame sequence, with the RTS/CTS sequence and other types of frame, such as a unicast management/control frame or a data frame, available in wireless LANs used in respect of the predicted station to allow the stations other than the predicted station to set the NAV timers thereof (in this case, the function to clear the NAV timer of the predicted station may not be necessary), thus attaining the same operation as described above.

Further taking account of the basic operation described earlier, another operation of the wireless LAN base station apparatus will be described, in which a voice communication by means of the VoIP protocol is also carried out between the terminal PC6 connected to the wired LAN 9 and the station STA2 connected to the wireless LAN 8.

Observing again the voice communication on the basis of the VoIP technology in the upward direction, FIG. 1, the access point AP1 receives periodically wireless frames including a packet of voice information sent from the station STA2. In reference to FIG. 2, the received frame is transferred through the RF processor 11 and the base-band processor 12 to the MAC processor 13, which in turn carries out thereon the MAC layer terminal processing. The processed frame then passes through the upper layer processor 18 to the wired LAN 9, and finally arrives at the terminal PC6.

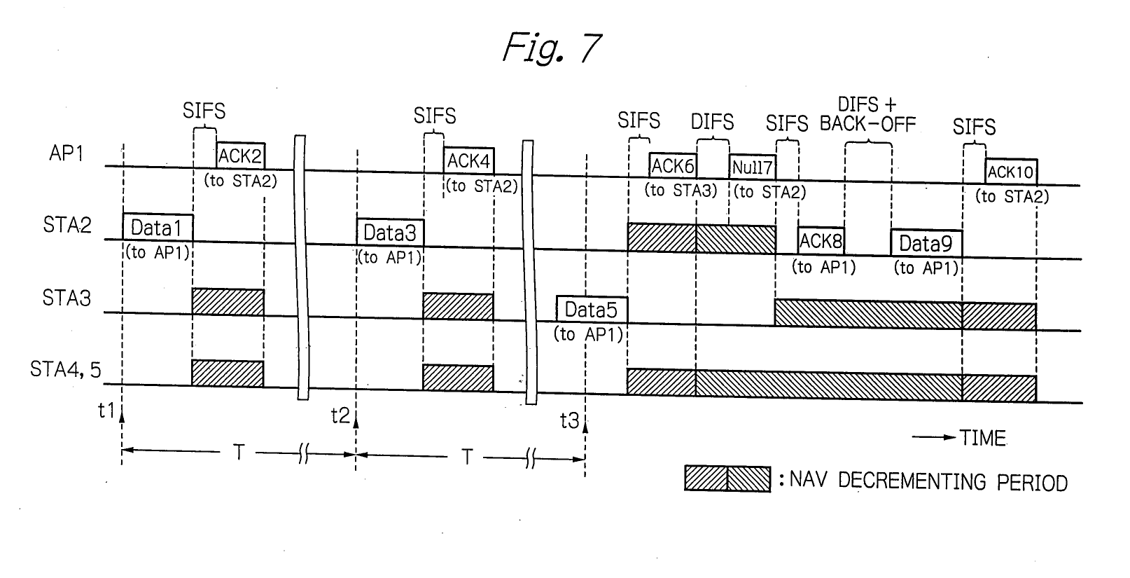

FIG. 7 is a timing chart useful for understanding how the frame are transmitted between the access point AP1 and the stations. In the figure, Data1 and Data3 represent the frames of the voice information transmitted from the station STA2 to the access point AP1 at the timing points t1 and t2 of the voice traffic generated in the upward direction, these frames being periodically generated at the time interval T. The access point AP1 stores data identifying the wireless station currently under voice communication, and predicts, based on the history, the timing of next voice traffic which is possibly generated in the upward direction. That timing is represented in the figure by t3 as the timing of the voice traffic generated in the upward direction.

In FIG. 7, it is also shown that, at the predicted timing, the access point AP1 is receiving Data5 from the station STA3. That prevents the station STA2 from being ready to immediately receive voice information following thereto. In this condition, the access point AP1 sets, when transmitting the frame ACK6 as a response to the frame Data5, the Duration value for acknowledgement, which is usually equal to “0”, to a value other than “0”. The latter value is calculated as the necessary time from the timing of the end of transmission of the frame ACK6 to the timing of the end of transmission of the frame ACK10, i.e. from the expression “DIFS×2+SIFS×2+back-off time+transmission time for (Null7, ACK8, Data9 and ACK10)”. In the calculation, the back-off time is a waiting time made by the back-off function of the station STA2. Since the back-off time is a random value not exactly predicable, it is set to a probable average value.

Now, at the other stations STA2, STA4 and STA5 that are not involved in the transmission and reception of the frames, their NAV timers, decrementing from the Duration value set in Data5, reach “0” at the timing of the end of transmission of the frame ACK6. Those timers then are again loaded with the Duration value set in the frame ACK6, and will continue to decrease.

The access point AP1, having transmitted the frame ACK6, confirms that the idle status of the wireless media has lasted for the successive DIFS time interval, and thereafter sends out the frame Null7 to the station STA2. The Frame Null7 has its Duration value set to a value resultant from the subtraction of “DIFS+transmission time for Frame Null7” from the Duration value for the frame ACK6.

The station STA2 receives the Frame Null7 to thereby clear its own NAV timer, and then sends the frame ACK8 as a response to the access point AP1. On the other hand, the station STA3, having received the Frame Null7 destined for the other station, loads its own NAV timer with the Duration value set in the frame Null7, and starts decreasing the timer. At this point of time, the station STA3 starts decrementing its NAV timer, and the other stations STA4 and STA5 still continue to decrement their NAV timers. Therefore, the station STA2 proceeds to the ordinary procedure (DIFS+back-off) before sending its frame Data9. Ultimately, the station STA2 will get the right of using the media with higher priority.

As described above, in summary, when the access point AP1 predicts, after the present receiving operation has finished, receiving of a multimedia frame with high-priority from an station, it loads the ACK frame to be sent with a Duration value that is not “0” but calculated from “DIFS×2+SIFS×2+back-off time+transmission time for (Null7, ACK8, Data9 and ACK10)” to cause the stations other than the station to which the ACK frame is sent to continue to decrement their NAV timers. Further, the access point AP1 carries out the Null/ACK sequence with respect to the predicted station. Therefore, it is possible to remarkably increase the probability at which the predicted station is able to secure its right of using the media next time in the upward direction, and also to improve the QoS of the wireless media in the upward direction.

In that way, the predicted station is caused to clear its NAV timer, thus assuring the predicted station to obtain its right of using the media next time in the upward direction. However, other types of frame, such as a unicast management/control frame or a data frame, available in wireless LANs may be used to clear the NAV timer of predicted stations, thus accomplishing the same operation as described above.

In addition, the ACK frame may have its Duration value smaller than the value described above, e.g. a value that reaches “0” during the succeeding frame sequence, with the Null/ACK sequence and other types of frame, such as a unicast management/control frame or a data frame, available in wireless LANs used in respect of the predicted station to allow the stations other than the predicted station to set the NAV timers thereof (in this case, the function to clear the NAV timer of the predicted station may not be necessary), thus attaining the same operation as described above.

On the basis of the basic operation described earlier, described will be a further operation of the wireless LAN base station apparatus, in which a voice communication using the VoIP protocol is also carried out between the terminal PC6 connected to the wired LAN 9 and the station STA2 connected to the wireless LAN 8.

Observing again the voice communication using the VoIP technology in the upward direction, the access point AP1, FIG. 1, periodically receives wireless frames including a packet of voice information sent from the station STA2. The received frame is applied through the RF processor 11 and the base-band processor 12, FIG. 2, to the MAC processor 13, which in turn carries out the MAC layer terminal processing. The resultant frame is then transferred through the upper layer processor 18 to the wired LAN 9, and finally arrives at the terminal PC6.

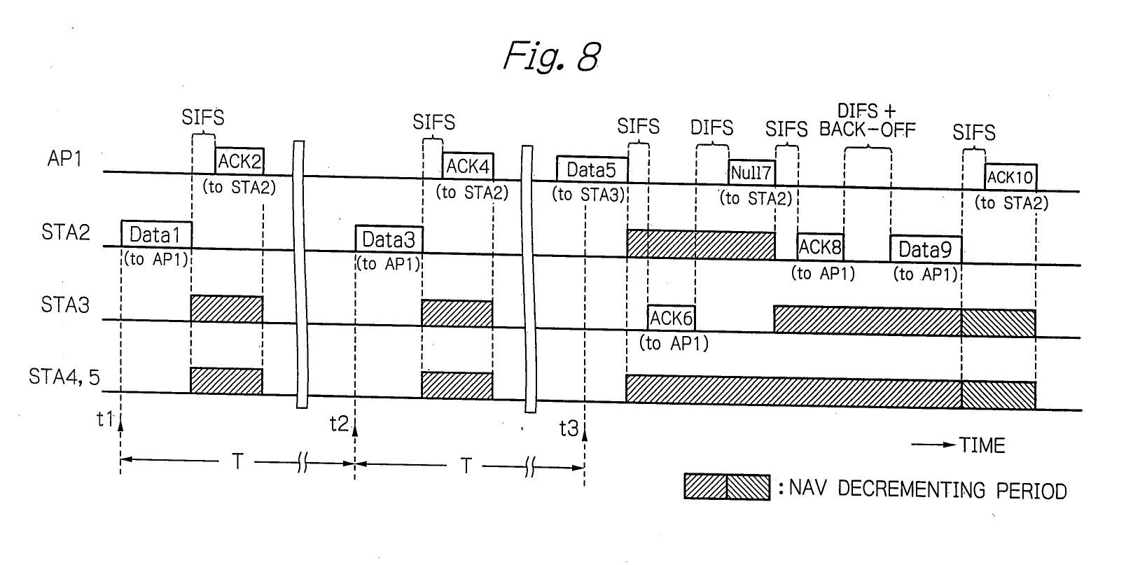

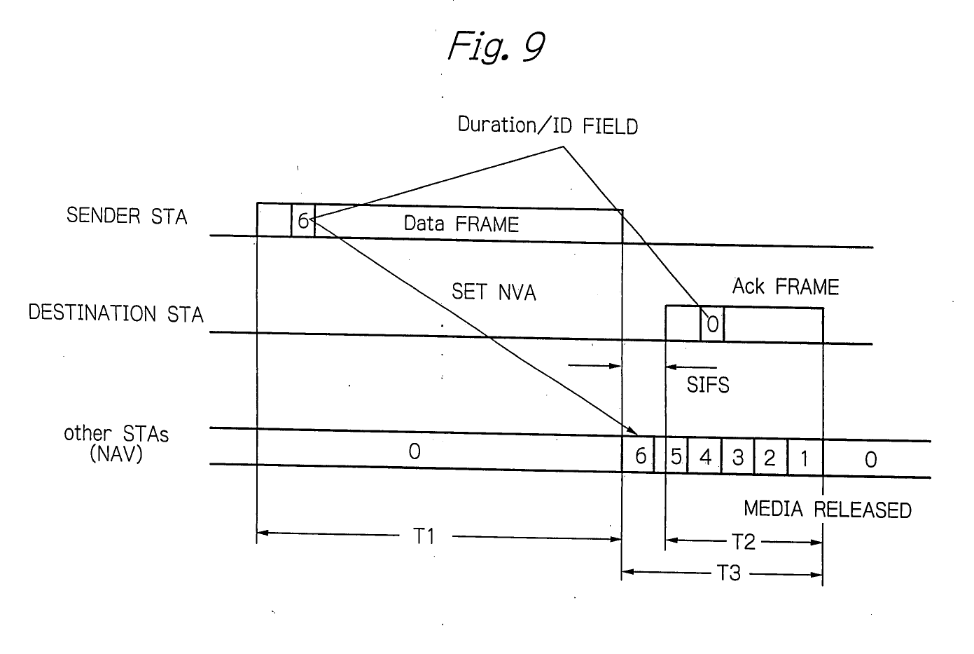

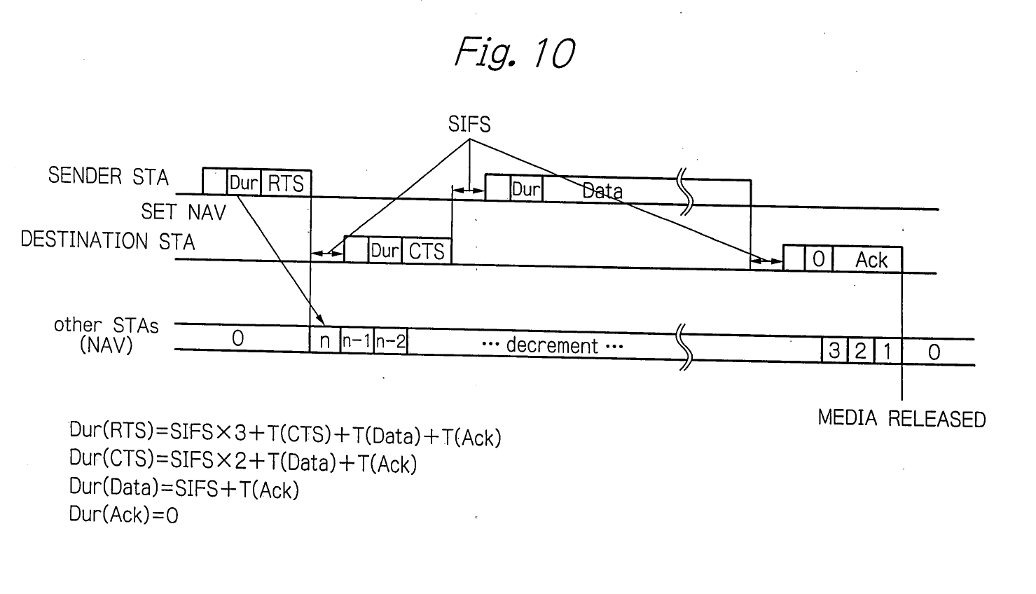

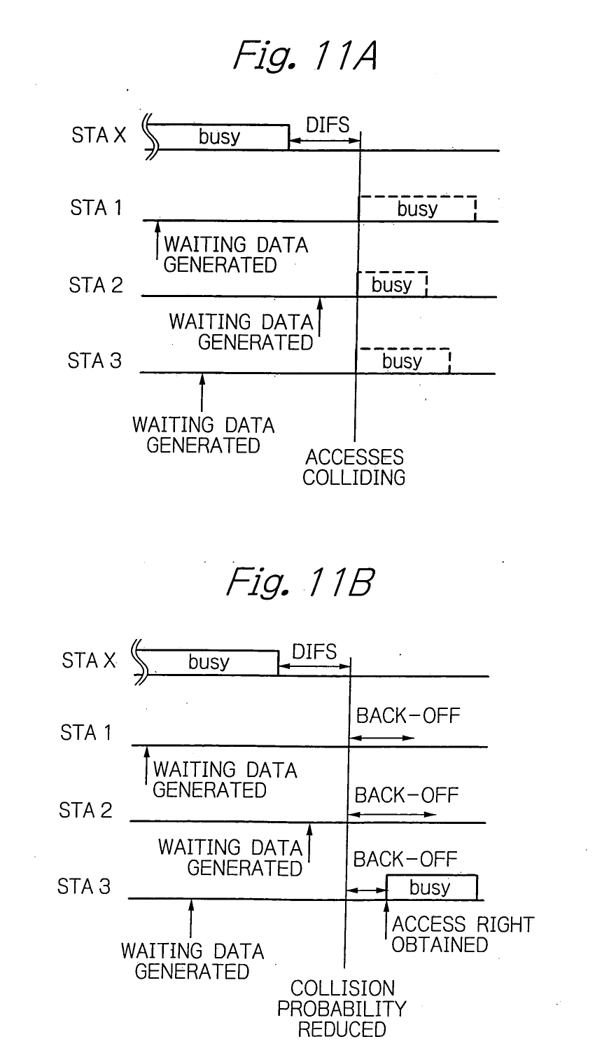

With reference to FIG. 8, a timing chart to demonstrate how to transmit frames to and from the access point AP1 and the stations, Data1 and Data3 represent the frames of the voice information transmitted from the station STA2 to the access point AP1 at the timing points t1 and t2 of the voice traffic generated in the upward direction, these frames being periodically generated at the time interval T. The access point AP1 stores data on the wireless station under the voice communication, and predicts, based on the history, the timing of voice traffic which may be generated next in the upward direction. The generation timing of the voice traffic in the upward direction is depicted with the indication t3.

In FIG. 8, it is also shown that, at the predicted timing, the access point AP1 is sending Data5 to the station STA3. The access point AP1 is therefore not able to immediately receive next voice information from the station STA2. Under this circumstance, the access point AP1 changes the Duration value to be set in the Data5 to a value larger than the ordinary value. That larger value is calculated as the necessary time from the timing of the end of transmission of the frame Data5 to the timing of the end of transmission of the frame ACK10, i.e. from the expression “DIFS×2+SIFS×3+back-off time+transmission time for (ACK6, Null7, ACK8, Data9 and ACK10)”. In the calculation, the back-off time is a waiting time made by the back-off function of the station STA2. Because the back-off time is a random value not exactly predicable, it is set to a probable average value.

Now, the other stations STA2, STA4 and STA5 that are not involved in the current transmission and reception of the frames load, at the timing of the end of transmission of the frame Data5, their NAV timers with the Duration value set in Data5 to start the decrement of them. The station STA3, having received the frame Data5, sends the frame ACK6 as a response to the access point AP1. The Duration value set in the ACK frame is predicted to be “0” as ordinarily. However, at the point of time, since the NAV timers of stations STA2, STA4 and STA5 still have values larger than “0”, and therefore they are not loaded with the Duration value “0” but continue to decrement.

The access point AP1, having received the frame ACK6, confirms that the idle status of the wireless media has lasted for the successive DIFS time interval, and thereafter sends the frame Null7 to the station STA2. As the Duration value for the frame Null7, set is a value obtained from the subtraction “DIFS+SIFS+transmission time for (ACK6 and Null7)” from the Duration value for the frame Data5.

The station STA2 receives the frame Null7, and in response clears its own NAV timer. The station STA2 then sends the frame ACK8 as a response to the access point AP1. On the other hand, the station STA3 receives the frame Null7 destined for the other station, and thereby loads its own NAV timer with the Duration value set in the frame Null7 to start decrementing the timer. At this point of time, the station STA3 starts decrementing its NAV timer, and the other stations STA4 and STA5 still continue to decrement their NAV timers. Therefore, the station STA2 proceeds to the ordinary procedure (DIFS+back-off) before sending its frame Data9. It is ultimately able to get the right of using the media with higher priority.

In summary, when the access point AP1 predicts, after the present sending procedure has finished, multimedia frames with the high-priority to be received from an station, it loads the Data frame to be sent with a Duration value that is larger than the ordinary value and is calculated from the expression “DIFS×2+SIFS×3+back-off time+transmission time for (ACK6, Null7, ACK8, Data9 and ACK10)”, and allows the stations other than the station to which the Data frame in question is transmitted to load their NAV timers with that value. Further, the access point AP1 carries out the Null/ACK sequence in terms of the predicted station. It is therefore possible to remarkably increase the probability at which the predicted station is able to secure its right of using the media next time in the upward direction, and also to improve the QoS of the wireless media in the upward direction.

In that way stated above, the predicted station is caused to clear its NAV timer, thus assuring the predicted station to obtain its right of using the media next time in the upward direction. However, other types of frame, such as a unicast management/control frame or a data frame, available in wireless LANs may be used to clear the NAV timer of predicted stations, thus accomplishing the same operation as described above.

Additionally, the Data frame may have its Duration value smaller than the value described above, e.g. a value that reaches “0” during the succeeding frame sequence, with the Null/ACK sequence and other types of frame, such as a unicast management/control frame or a data frame, available in wireless LANs used in respect of the predicted station to allow the stations other than the predicted station to set the NAV timers thereof (in this case, the function to clear the NAV timer of the predicted station may not be necessary), thus attaining the same operation as described above.

The present invention is advantageously applied to apparatus of the kind, such as VoIP apparatus and moving picture communication apparatus, which deals in a system according to IEEE 802.11 standard with various kinds of multimedia information and the maintaining QoS for wireless LANs is an important factor.

The entire disclosure of Japanese patent application No. 2004-355578 filed on Dec. 8, 2004, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A method of controlling quality of service for wireless base station apparatus used in a wireless local area network system operating in accordance with IEEE (Institute of Electrical and Electronic Engineers) 802.11 standard, wherein
the base station is included in a network working in an infrastructure mode with a mobile station controlled in access by a DCF (Distributed Coordination Function) function,
the base station, when the base station is receiving a first frame sent from the mobile station and holds a multimedia frame which is to be sent with high-priority after having received the first frame, loading a Duration/ID (Identification) field of an acknowledgement frame responding to the first frame with a period of time required for, or securing a right of, transmitting the multimedia frame to send the acknowledgement frame.

2. A method of controlling quality of service for wireless base station apparatus used in a wireless local area network system operating in accordance with IEEE (Institute of Electrical and Electronic Engineers) 802.11 standard, wherein
the base station is included in a network working in an infrastructure mode with a mobile station controlled in access by a DCF (Distributed Coordination Function) function,
the base station, when the base station is transmitting a first frame to the mobile station and holds a multimedia frame which is to be sent with high-priority after having transmitted the first frame, loading a Duration/ID (Identification) field of the first frame with a period of time added by a time required for, or securing a right of, transmitting the multimedia frame to send the first frame.

3. A method of controlling quality of service for wireless base station apparatus used in a wireless local area network system operating in accordance with IEEE (Institute of Electrical and Electronic Engineers) 802.11 standard, wherein
the base station is included in a network working in an infrastructure mode with a mobile station controlled in access by a DCF (Distributed Coordination Function) function,
the base station, when the base station is receiving a first frame sent from the mobile station and predicts a reception of a multimedia frame with high-priority from a specific mobile station after having received the first frame, loading a Duration/ID (Identification) field of an acknowledgement frame responding to the first frame with a period of time required for receiving at least part of the multimedia frame predicted to send the acknowledgement frame,
the base station thereafter executing, with the specific mobile station, a sequence of clearing a NAV (Network Allocation Vector) timer of the specific mobile station.

4. The method in accordance with claim 3, wherein the sequence is an RTS/CTS (Request To Send/Clear To Send) sequence.

5. The method in accordance with claim 3, wherein the sequence is a Null/ACK (Acknowledgement) sequence.

6. A method of controlling quality of service for wireless base station apparatus used in a wireless local area network system operating in accordance with IEEE (Institute of Electrical and Electronic Engineers) 802.11 standard, wherein
the base station is included in a network working in an infrastructure mode with a mobile station controlled in access by a DCF (Distributed Coordination Function) function,
the base station, when the base station is transmitting a first frame sent to the mobile station and predicts a reception of a multimedia frame with high-priority from a specific mobile station after having transmitted the first frame, loading a Duration/ID (Identification) field of the first frame with a period of time added by a time required for receiving at least part of the multimedia frame predicted to send the first frame,
the base station thereafter executing, with the specific mobile station, a sequence of clearing a NAV (Network Allocation Vector) timer of the specific mobile station.

7. The method in accordance with claim 6, wherein the sequence is an RTS/CTS (Request To Send/Clear To Send) sequence.

8. The method in accordance with claim 6, wherein the sequence is a Null/ACK (Acknowledgement) sequence.

9. A method of controlling quality of service for wireless base station apparatus used in a wireless local area network system operating in accordance with IEEE (Institute of Electrical and Electronic Engineers) 802.11 standard, wherein
the base station is included in a network working in an infrastructure mode with a mobile station controlled in access by a DCF (Distributed Coordination Function) function,
the base station, when the base station is receiving a first frame sent from the mobile station and predicts a reception of a multimedia frame with high-priority from a specific mobile station after having received the first frame, loading a Duration/ID (Identification) field of an acknowledgement frame responding to the first frame with a period of time required for, or securing a right of, transmitting a specific frame to send the acknowledgement frame,
the base station thereafter executing, with the specific mobile station, a sequence of setting a NAV (Network Allocation Vector) timer of a mobile station other than the specific mobile station.

10. The method in accordance with claim 9, wherein the sequence is an RTS/CTS (Request To Send/Clear To Send) sequence.

11. The method in accordance with claim 9, wherein the sequence is a Null/ACK (Acknowledgement) sequence.

12. A method of controlling quality of service for wireless base station apparatus used in a wireless local area network system operating in accordance with IEEE (Institute of Electrical and Electronic Engineers) 802.11 standard, wherein
the base station is included in a network working in an infrastructure mode with a mobile station controlled in access by a DCF (Distributed Coordination Function) function,
the base station, when the base station is transmitting a first frame to the mobile station and predicts a reception of a multimedia frame with high-priority from a specific mobile station after having transmitted the first frame, loading a Duration/ID (Identification) field of the first frame with a period of time added by a time required for, or securing a right of, transmitting a specific frame to send the first frame,
the base station thereafter executing, with the specific mobile station, a sequence of setting a NAV (Network Allocation Vector) timer of a mobile station other than the specific mobile station.

13. The method in accordance with claim 12, wherein the sequence is an RTS/CTS (Request To Send/Clear To Send) sequence.

14. The method in accordance with claim 12, wherein the sequence is a Null/ACK (Acknowledgement) sequence.
